(19) United States
(12) Patent Application Publication
(10) Pub. No.: US 2006/0184770 A1
(43) Pub. Date: Aug. 17, 2006

(54) Method of implementing precise, localized hardware-error workarounds under centralized control

(75) Inventors: James W. Bishop, Leander, TX (US); Michael S. Floyd, Austin, TX (US); Hung Q. Le, Austin, TX (US); Larry S. Leitner, Austin, TX (US); Brian W. Thompto, Austin, TX (US)

Correspondence Address: IBM CORPORATION (SYL);C/O SYNNESTVEDT & LECHNER LLP, 1101 MARKET STREET, SUITE 2600, PHILADELPHIA, PA, 19107, US

(73) Assignee: International Business Machines Corporation, Armonk, NY (US)

(21) Appl. No.: 11/056,878

(22) Filed: Feb. 12, 2005

(51) Int. Cl. G06F 9/40

(52) U.S. Cl. 712/216

(57) ABSTRACT

In a processor, a localized workaround is activated upon the sensing of a problematic condition occurring on said processor, and then control of the deactivation of the localized workaround is superseded by a centralized controller. In a preferred embodiment, the centralized controller monitors forward progress of the processor and maintains the workaround in an active condition until a threshold level of forward progress has occurred. Optionally, the localized workaround may be re-activated while under centralized control, resetting the notion of forward progress. Using the present invention, localized workarounds perform effectively while having a minimal impact on processor performance.

### BACKGROUND OF THE INVENTION

1. Field of the Invention

The present invention relates generally to an improved data processing system and in particular to a method and apparatus for controlling the operations of localized workarounds that bypass or compensate for errors or other anomalies in the data processing system.

2. Description of the Related Art

Modern processors commonly use a technique known as pipelining to improve performance. Pipelining is an instruction execution technique that is analogous to an assembly line. Consider that instruction execution often involves the sequential steps of fetching the instruction from memory, decoding the instruction into its respective operation and operand(s), fetching the operands of the instruction, applying the decoded operation on the operands (herein simply referred to as “executing” the instruction), and storing the result back in memory or in a register. Pipelining is a technique wherein the sequential steps of the execution process are overlapped for a sub-sequence of the instructions. For example, while the CPU is storing the results of a first instruction of an instruction sequence, the CPU simultaneously executes the second instruction of the sequence, fetches the operands of the third instruction of the sequence, decodes the fourth instruction of the sequence, and fetches the fifth instruction of the sequence. Pipelining can thus decrease the execution time for a sequence of instructions.

Another technique for improving performance involves executing two or more instructions in parallel, i.e., simultaneously. Processors that utilize this technique are generally referred to as superscalar processors. Such processors may incorporate an additional technique in which a sequence of instructions may be executed out of order. Results for such instructions must be reassembled upon instruction completion such that the sequential program order or results are maintained. This system is referred to as out of order issue with in-order completion.

The ability of a superscalar processor to execute two or more instructions simultaneously depends upon the particular instructions being executed. Likewise, the flexibility in issuing or completing instructions out-of-order can depend on the particular instructions to be issued or completed. There are three types of such instruction dependencies, which are referred to as: resource conflicts, procedural dependencies, and data dependencies. Resource conflicts occur when two instructions executing in parallel tend to access the same resource, e.g., the system bus. Data dependencies occur when the completion of a first instruction changes the value stored in a register or memory, which is later accessed by a later completed second instruction.

During execution of instructions, an instruction sequence may fail to execute properly or to yield the correct results for a number of different reasons. For example, a failure may occur when a certain event or sequence of events occurs in a manner not expected by the designer. Further, an error also may be caused by a misdesigned circuit or logic equation. Due to the complexity of designing an out of order processor, the processor design may logically miss-process one instruction in combination with another instruction, causing an error. In some cases, a selected frequency, voltage, or type of noise may cause an error in execution because of a circuit not behaving as designed. Errors such as these often cause the scheduler in the microprocessor to “hang”, resulting in execution of instructions coming to a halt. A hang may also result due to a “live-lock”—a situation where the instructions may repeatedly attempt to execute, but cannot make forward progress due to a hazard condition. For example, in a simultaneous multi-threaded processor, multiple threads may block each other if there is a resource interdependency that is not properly resolved. Errors do not always cause a “hang”, but may also result in a data integrity problem where the processor produces incorrect results. A data integrity problem is even worse than a “hang” because it may yield an indeterminate and incorrect result for the instruction stream executing.

These errors can be particularly troublesome when they are missed during simulation and thus find their way onto already manufactured hardware systems. In such cases, large quantities of the defective hardware devices may have already been manufactured, and even worse, may already be in the hands of consumers. For such situations, it is desirable to formulate workarounds which allow such problems to be bypassed or minimized so that the defective hardware elements can be used.

Prior art workaround techniques have involved throttling the performance of the processor by stalling pipeline states of the processor or by implementing other coarse-grained modes, such as limited superscalar execution or instruction serialization. While these methods do help in getting around the bug or enabling processing to continue in spite of the bug, they are not without their drawbacks. For example, course-grained modes can adversely affect the performance of code streams that will never encounter the bug, i.e., the workaround is an overkill. In addition, due to wiring constraints on the processor itself, only a limited number of high-level reduced execution modes can be made available in the design. Further, such a global reduced execution modes do not take into account localized workaround techniques available within a unit of the processor, but not externally visible to the unit. As a result of these drawbacks, the bug workaround is often not worth implementing due to the severe performance impact.

Recent workaround designs have implemented more localized (sometimes referred to as “surgical”) fixes, dynamically, using “chicken switches” internal to the processor unit. Chicken switches are switches that can disable elements of the chip to isolate problems, and they typically are engaged by a localized triggering facility. However, it may be difficult to control the windows in which the workarounds should be enabled, and more specifically, it may be difficult to determine when it is safe to reset the workaround. For example, if the workaround is engaged for a predetermined period of processor clock cycles, the workaround may not be effective due to variations in execution timing that can delay internal processor events for many thousands of cycles. Alternatively, the workaround could be reset based on a known safe state condition, but a safe state is often difficult or impossible to identify, and also may not occur for very long time, thereby keeping the workaround engaged past the required window and possibly having a detrimental effect on processor performance.

Accordingly, it would be advantageous to have a method and apparatus taking advantage of the precision afforded by localized, surgical bug workarounds, while being able to dynamically control their engagement and disengagement to minimize any negative performance impact.

### SUMMARY OF THE INVENTION

The present invention allows localized triggers to be engaged until it is sensed that the problem scenario has most likely passed. In accordance with the present invention, a localized workaround is activated, and then control of the deactivation of the localized workaround is superseded by a centralized controller. In a preferred embodiment, the centralized controller monitors forward progress of the processor and maintains the workaround in an active condition until a threshold level of forward progress has occurred. Optionally, the localized workaround may be re-activated while under centralized control, resetting the notion of forward progress. Using the present invention, localized workarounds perform effectively while having a minimal impact on processor performance.

### BRIEF DESCRIPTION OF THE DRAWINGS

FIG. 1 is a block diagram illustrates a data processing system in which the present invention;

FIG. 2 illustrates a portion of a processor core configured in accordance with a preferred embodiment of the present invention;

FIG. 3 is a block diagram showing a simplified view of the triggering and workaround logic within a single processor unit; and

FIGS. 4 and 5 are flow charts illustrating the basic operations performed for the handling of local workarounds by a processor unit with workaround capability in accordance with the present invention.

### DETAILED DESCRIPTION OF THE PREFERRED EMBODIMENTS

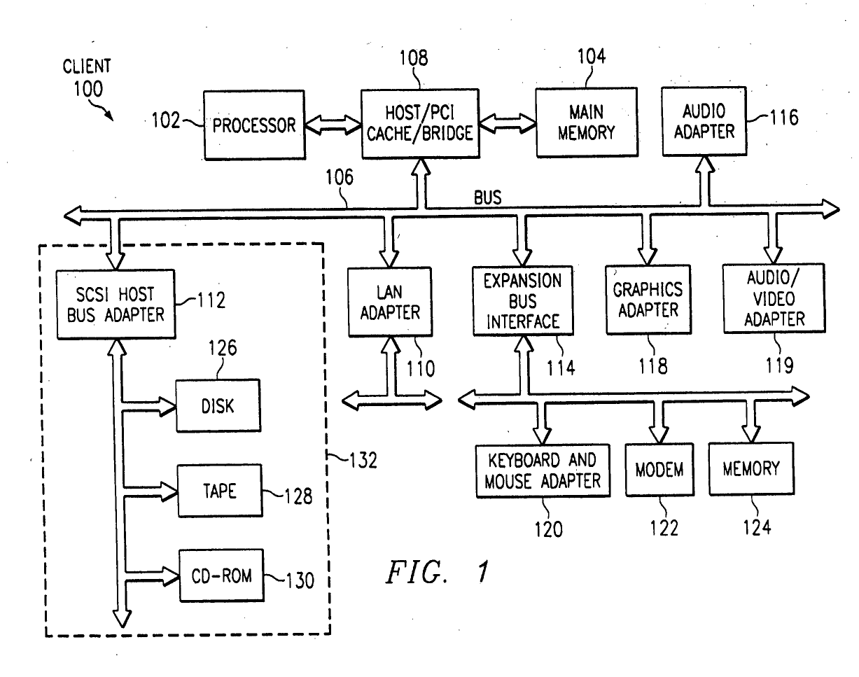

With reference now to FIG. 1, a block diagram illustrates a data processing system in which the present invention may be implemented. Data processing system 100 is an example of a client computer. Data processing system 100 employs a peripheral component interconnect (PCI) local bus architecture. Although the depicted example employs a PCI bus, other bus architectures such as Accelerated Graphics Port (AGP) and Industry Standard Architecture (ISA) may be used. Processor 102 and main memory 104 are connected to PCI local bus 106 through PCI bridge 108. PCI bridge 108 also may include an integrated memory controller and cache memory for processor 102. Additional connections to PCI local bus 106 may be made through direct component interconnection or through add-in boards. In the depicted example, local area network (LAN) adapter 110, SCSI host bus adapter 112, and expansion bus interface 114 are connected to PCI local bus 106 by direct component connection. In contrast, audio adapter 116, graphics adapter 118, and audio/video adapter 119 are connected to PCI local bus 106 by add-in boards inserted into expansion slots. Expansion bus interface 114 provides a connection for a keyboard and mouse adapter 120, modem 122, and additional memory 124. Small computer system interface (SCSI) host bus adapter 112 provides a connection for hard disk drive 126, tape drive 128, and CD-ROM drive 130. Typical PCI local bus implementations will support three or four PCI expansion slots or add-in connectors.

An operating system runs on processor 102 and is used to coordinate and provide control of various components within data processing system 100 in FIG. 1. The operating system may be a commercially available operating system such as AIX, which is available from International Business Machines Corporation. Instructions for the operating system and applications or programs are located on storage devices, such as hard disk drive 126, and may be loaded into main memory 104 for execution by processor 102.

Those of ordinary skill in the art will appreciate that the hardware in FIG. 1 may vary depending on the implementation. Other internal hardware or peripheral devices, such as flash ROM (or equivalent nonvolatile memory) or optical disk drives and the like, may be used in addition to or in place of the hardware depicted in FIG. 1. Also, the processes of the present invention may be applied to a multiprocessor data processing system.

For example, data processing system 100, if optionally configured as a network computer, may not include SCSI host bus adapter 112, hard disk drive 126, tape drive 128, and CD-ROM 130, as noted by dotted line 132 in FIG. 1 denoting optional inclusion. The data processing system depicted in FIG. 1 may be, for example, an IBM RISC/System 6000 system, a product of International Business Machines Corporation in Armonk, N.Y., running the Advanced Interactive Executive (AIX) operating system. The depicted example in FIG. 1 and above-described examples are not meant to imply architectural limitations.

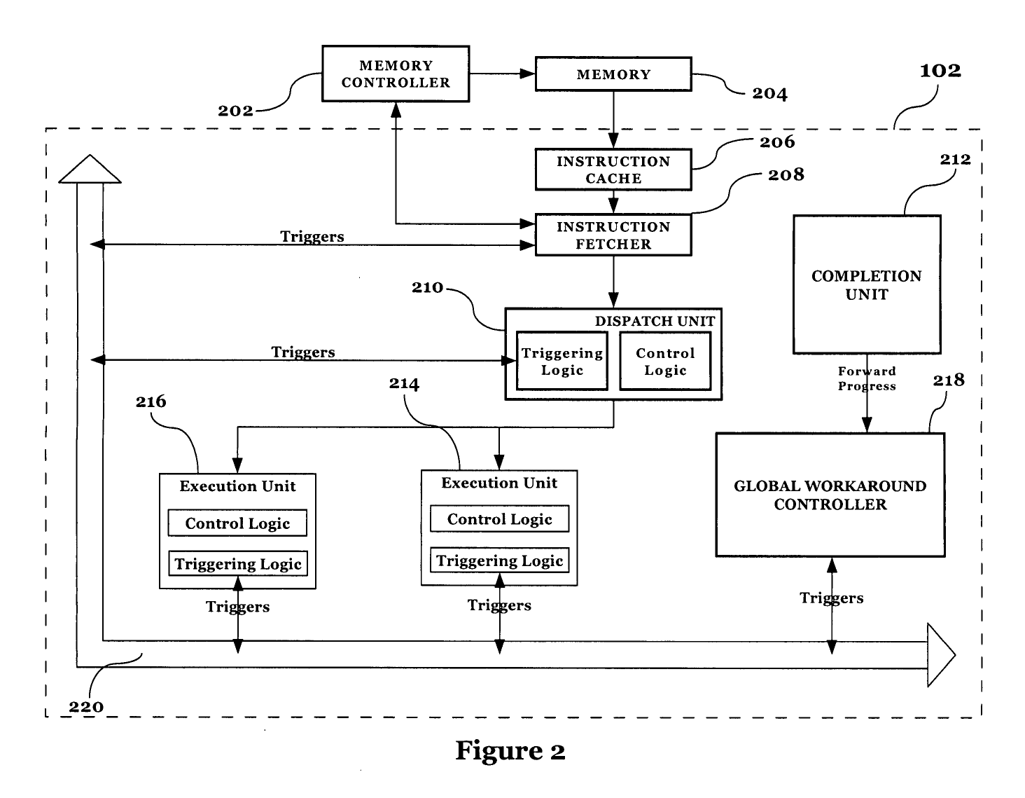

The mechanism of the present invention may be implemented within processor 102. With reference next to FIG. 2, a diagram of a portion of a processor core is depicted in accordance with a preferred embodiment of the present invention. Section 200 illustrates a portion of a processor core for a processor, such as processor 102 in FIG. 1. Only the components needed to illustrate the present invention are shown in section 200. Other components are omitted in order to avoid obscuring the invention.

Referring to FIG. 2, processor 102 is connected to a memory controller 202 and a memory 204 which may also include a L2 cache. As is well known, the memory 202 and memory controller 204 function to provide storage, and control access to the storage, for the processor 102.

The processor 102 of the present invention includes an instruction cache 206, and instruction fetcher 208. An instruction fetcher 208 maintains a program counter and fetches instructions from instruction cache 206 and from more distant memory 204 that may include a L2 cache. The program counter of instruction fetcher 208 comprises an address of a next instruction to be executed. The L1 cache 206 is located in the processor and contains data and instructions preferably received from an L2 cache in memory 204. Ideally, as the time approaches for a program instruction to be executed, the instruction is passed with its data, if any, first to the L2 cache, and then as execution time is near imminent, to the L1 cache. Thus, instruction fetcher 208 communicates with a memory controller 202 to initiate a transfer of instructions from a memory 204 to instruction cache 206. Instruction fetcher 208 retrieves instructions passed to instruction cache 206 and passes them to an instruction dispatch unit 210.

Instruction dispatch unit 210 receives and decodes the instructions fetched by instruction fetcher 208. The dispatch unit 210 may extract information from the instructions used in determination of which execution units must receive the instructions. The instructions and relevant decoded information may be stored in an instruction buffer or queue (not shown) within the dispatch unit 210. The instruction buffer within dispatch unit 210 may comprise memory locations for a plurality of instructions. The dispatch unit 210 may then use the instruction buffer to assist in reordering instructions for execution. For example, in a multi-threading processor, the instruction buffer may form an instruction queue that is a multiplex of instructions from different threads. Each thread can be selected according to control signals received from control circuitry within dispatch unit 210 or elsewhere within the processor 102. Thus, if an instruction of one thread becomes stalled, an instruction of a different thread can be placed in the pipeline while the first thread is stalled.

Dispatch unit 210 may also comprise a recirculation buffer mechanism (not shown) to handle stalled instructions. The recirculation buffer is able to point to instructions in instruction buffer contained within dispatch unit 210 that have already been dispatched, but are unable to execute successfully at the time they reach a particular stage in the pipeline. If an instruction is stalled because of, for example, a data cache miss, the instruction can be re-dispatched by dispatch unit 210 to be re-executed. This is faster than retrieving the instruction from the instruction cache. By the time the instruction again reaches the stage where the data is required, the data may have by then been retrieved. Alternatively, the instruction can be re-dispatched only after the needed data is retrieved. When an instruction is stalled and needs to be reintroduced to the pipeline it is said to be rejected. Frequently the condition that prevents successfully execution is such that the instruction will be likely to execute successfully if re-executed as soon as possible.

Dispatch unit 210 dispatches the instruction to execution units (214 and 216). For purposes of example, but not limitation, only two execution units are shown in FIG. 2. In a superscalar architecture, execution units (214 and 216) may comprise load/store units, integer Arithmetic/Logic Units, floating point Arithmetic/Logic Units, and Graphical Logic Units, all operating in parallel. Dispatch unit 210 therefore dispatches instructions to some or all of the executions units to execute the instructions simultaneously. Execution units (214 and 216) comprise stages to perform steps in the execution of instructions received from dispatch unit 210. Data processed by execution units (214 and 216) are storable in and accessible from integer register files and floating point register files not shown. Data stored in these register files can also come from or be transferred to an on-board data cache or an external cache or memory.

Dispatch unit 210, and other control circuitry (not shown) include instruction sequencing logic to control the order that instructions are dispatched to execution units (214 and 216). Such sequencing logic may provide the ability to execute instructions both in order and out-of-order with respect to the sequential instruction stream. Out-of-order execution capability can enhance performance by allowing for younger instructions to be executed while older instructions are stalled.

Each stage of each of execution units (214 and 216) is capable of performing a step in the execution of a different instruction. In each cycle of operation of processor 102, execution of an instruction progresses to the next stage through the processor pipeline within execution units (214 and 216). Those skilled in the art will recognize that the stages of a processor “pipeline” may include other stages and circuitry not shown in FIG. 2. In a multi-threading processor, each pipeline stage can process a step in the execution of an instruction of a different thread. Thus, in a first cycle, a particular pipeline stage 1 will perform a first step in the execution of an instruction of a first thread. In a second cycle, next subsequent to the first cycle, a pipeline stage 2 will perform a next step in the execution of the instruction of the first thread. During the second cycle, pipeline stage 1 performs a first step in the execution of an instruction of a second thread. And so forth.

Completion unit 212 provides a means for tracking instructions as they finish execution, and for ordering the update of architected facilities of the processor in sequential program order. In one embodiment the completion unit 212 monitors instruction finish reports from execution units and responds to execution exceptions by redirecting the instruction stream to an exception handler from the point of the exception. As such, the completion unit 212 maintains a view of progress through the instruction stream for each thread of execution and may indicate such status to global workaround controller 218.

In one embodiment, the localized workaround may be initiated by localized triggering logic distributed throughout the processor core. Trigger logic may reside within instruction fetcher 208, dispatch unit 210, execution units (214 and 216), completion unit 212, and in other locations (not shown) throughout the processor core. The triggering logic is designed to have access to local and inter-unit indications of processor state, and uses such state to detect a condition after which to initiate a workaround and inform global workaround controller 218 of said condition. Inter-unit indications of processor state may be passed between units via inter-unit triggering bus 220. Triggering bus 220 may have a static set of indications from each processor unit, or in a preferred embodiment, may have a configurable set of processor state indications. Triggering logic in processor execution units may have access to much more internal state information then external (or inter-unit) state information because the width of inter-unit trigger bus 220 may be limited by global wiring constraints.

The configuration of triggering logic to initiate localized workarounds and the configuration of the set of processor states available on triggering bus 220 are determined once there is a known hardware error for which a workaround is desired. The triggers can then be programmed to look for the particular scenario in which the workaround should be engaged. These triggers can be direct or can be event sequences such as A happened before B, or slightly more complex, such as A happened within three cycles of B. However, the capability of triggering logic within the processor units may be limited due to the small number of state latches that may be afforded to the logic because of area constraints.

An example error condition for which a localized workaround may be desired is the case of a “live-lock” between threads in a SMT processor due to a resource contention within execution units 214 and 216. Continuing with this example, let us consider the case where each of two threads has one load instruction dispatched by dispatch unit 210 in same cycle. The first thread may dispatch to execution unit 214, while the second thread may dispatch to execution unit 216. Each time the instructions from the two threads reach a stage n in the execution pipelines, they both compete for a shared resource, due to a design flaw, neither instruction is granted the shared resource and so both instructions are rejected by their respective execution units. In such a case, the two threads may continue to dispatch and reject in this manner with neither thread making any forward progress, resulting in a processor “hang”. Upon analysis of the failure mechanism it may be determined that a localized workaround may be engaged to prevent the problem condition dynamically and without detriment to processor performance. If the scenario can be detected, then one of the execution units can request that dispatch be halted for one of the two competing threads, and the “live-lock” can be broken. For this example embodiment, execution unit 214 and execution unit 216 each has an internal “resource reject” event available to the local triggering logic. Furthermore, triggering logic of each execution unit has access to the corresponding event from the other execution unit via the inter-unit triggering bus. To activate a trigger and enable the localized workaround when the problem scenario occurs, the triggering logic of execution unit 214 may be configured to look for an internal “resource-reject” event coincident with a remote “resource-reject” event from execution unit 216. By configuring the local triggering logic as such, the problem scenario can be detected, and a trigger can be generated within execution unit 214 to engage the workaround. Once engaged, execution unit 214 will send a signal to the global workaround controller 218.

The need for the centralized control provided by global workaround controller 218 of the present invention is evident if we further consider the case where the triggering logic for execution unit 214 may not have enough information to determine when the resource contention has been resolved, and when the workaround can be safely deactivated. For example, dispatch unit 210 may stall both threads for various reasons, such as for a dynamically engaged power savings mode where the threads will be stalled together for hundreds or thousands of cycles. If the localized workaround of this example is controlled only by the local trigger control, then it may be programmed to be active for a fixed duration of processor cycles. However, the duration must be made sufficiently long to break out of the “live-lock” in all cases including the described power savings mode. In order to cover this case then, the local trigger control must set the activation period high enough to cover the longest possible delay before re-dispatch, which in this example may be thousands of cycles. Therefore if the localized workaround is setup to work in all cases it must stall the chosen thread for thousands of cycles to guarantee the resource conflict is ended, or when the dispatch finally resumes the resource contention will repeat and the “live-lock” will not be broken. This requirement is likely to yield an unacceptable performance impact since in many cases the power management scheme will be deactivated and the workaround may then engage for any unnecessarily long duration. By engaging the global workaround controller 218 and allowing the it to take over as a centralized control on the workaround, the problem may be avoided because global workaround control 218 can monitor forward progress in the instruction stream and disengage the local workaround as soon as one of the threads makes any forward progress.

Global workaround controller 218 accordingly provides a centralized control for keeping the localized workaround active until a pre-configured amount of forward-progress has been monitored. When a localized workaround operation is initiated in processor 102, global workaround controller 218 senses the initiation of the workaround through the use of a trigger received from each unit's triggering logic. In a preferred embodiment, the triggers may be a part of the inter-unit trigger bus 220. Upon sensing of the trigger indicating initiation of the workaround, the global workaround controller 218 sets the processor into a mode where it monitors a configurable measure of forward progress, with said forward progress monitoring logic being contained within the global workaround controller 218. Once global workaround controller 218 activates this forward-progress-monitoring mode it will send an indication to the processor units to keep any configured workarounds active. In one embodiment global workaround controller 218 may have multiple forward progress state machines, each configured to react to a trigger from a different unit, and correspondingly each sending out a separate trigger to each of the execution units.

When the initial trigger activates the workaround, the processor units are caused, via appropriate programming, to enter whatever workaround mode has been implanted and configured. Numerous workaround modes are known in the art and any workaround mode may be implemented, e.g. the unit might enter a reduced execution mode, or activate a workaround feature to avoid or bypass problematic “windows” of instructions. With the local activation of the workaround itself having a predetermined duration (e.g., 10 cycles of the processor) and with the global workaround controller 218 having its own criteria for controlling the deactivation of the workaround, the workaround will continue until both criteria (e.g., the completion of the 10 cycles and a determination that appropriate forward progress has been made) so as to assure that it is safe to exit the workaround mode.

In a preferred embodiment, the localized workaround control should keep the local workaround state active at least for the number of cycles it takes for the global workaround controller trigger to be received by the control logic configured to engage a workaround (so that the centralized control has a chance to take control of the deactivation). Once the configured amount of forward progress has been made, the global workaround controller drops its trigger, thereby removing it form the control loop.

The global workaround controller 218 will detect forward progress by, for example, sensing the completion of certain instructions, or by the reaching of a “checkpoint” within the processing code, or by receiving a trigger indicating that a predetermined measure of forward progress has occurred with respect to the workaround. In a preferred embodiment, this configuration includes the option of tracking instruction completion events as indicated by completion unit 212. In an alternative embodiment, global workaround controller 218 also contains a set of event driven state-machines, similar to a logic analyzer, that may produce configurable triggers used as a notion of forward progress and that may be configured to utilize the triggers on inter-unit trigger bus 220 and the forward progress indications from completion unit 212.

In one embodiment of the present invention, processor 102 is a SMT processor, and the facilities of the invention are replicated per thread such that independent workaround actions may be taken on each thread independently. Global workaround controller 218 may be replicated per thread, or separate facilities may be kept internal to the workaround controller 218 for tracking each thread.

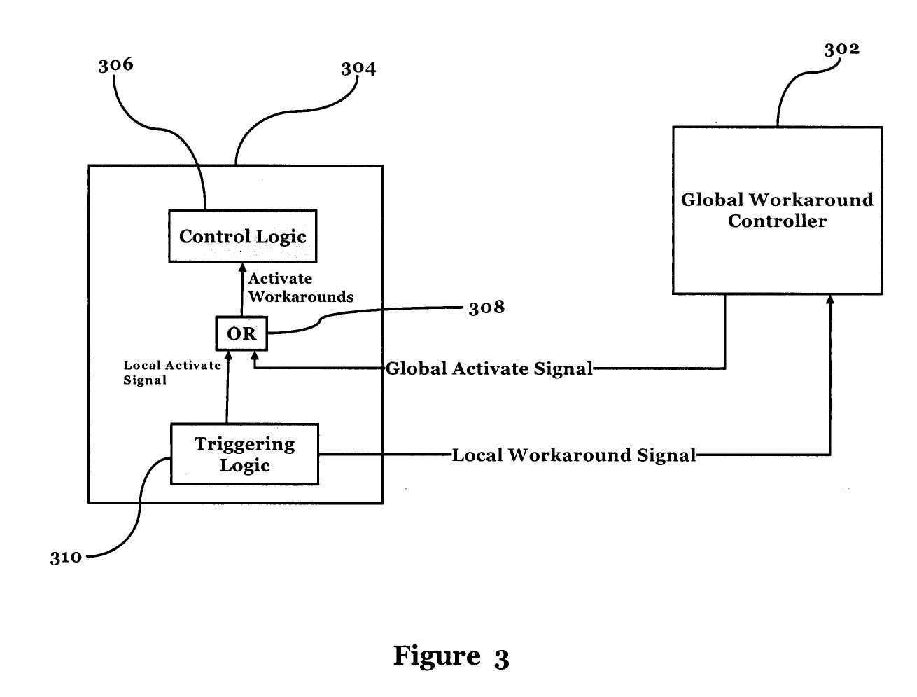

FIG. 3 is a block diagram showing a simplified view of the triggering and workaround logic within a single processor unit 304 (representing any of execution units 214 and 216, dispatch unit 210, instruction fetcher 208 or completion unit 212, or any others not shown) and the interface of such logic to the global workaround controller 302 (218). The local triggering logic 310 is configured to monitor internal and external triggers for a specific event or event sequence. Once an event is detected, the triggering logic 310 activates an internal counter and sends a “Local Activate Signal” to control logic 306 that will engage any independently enabled workarounds. Also when said event is detected, the triggering logic 310 will inform the global workaround controller 302 of the event by sending a “Local Workaround Signal”. In one embodiment, this signal may be a generic trigger that can be configured for this purpose when the workaround is configured. In response to the “Local Workaround Signal” the global workaround controller 302 resets its forward progress counter and activates the “Global Activate Signal” to the processor unit 304, which again may be a generic trigger that can be configured for this purpose when the workaround is configured. When the processor unit 304 receives the “Global Activate Signal” it will perform a logical OR (308) between the “Global” and “Local” activate signals before sending the combined signal, “Activate Workarounds” to control logic 306. Once the “Global Activate Signal” is received, any independently enabled workarounds will continue to be engaged, even once the “Local Activate Signal” is de-activated. Once the internal counter contained in triggering logic 310 expires, the “Local Activate Signal” will be deactivated, leaving the global workaround controller 302 in full control of deactivating the workaround. Once the global workaround controller 302 determines the preconfigured amount of forward progress has been made it will deactivate “Global Active Signal”, and correspondingly the “Activate Workarounds” signal will also deactivate restoring the processor operation to normal.

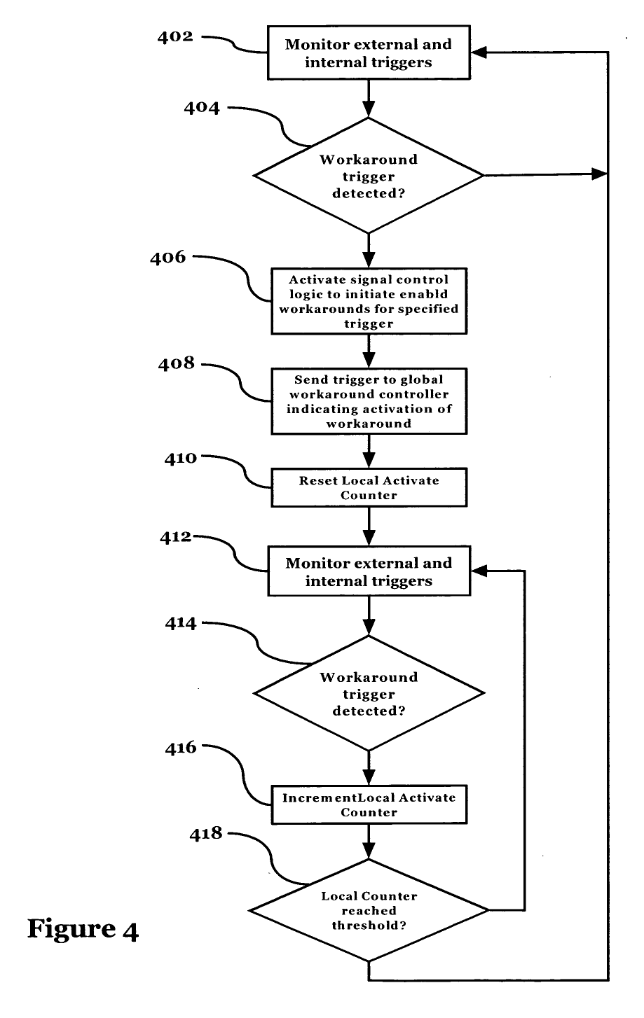

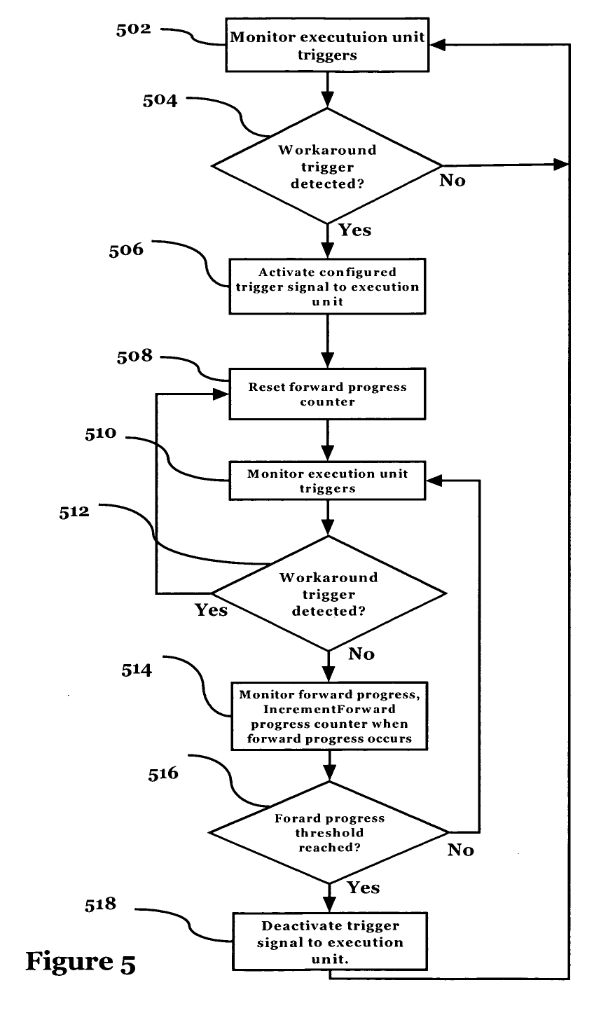

FIGS. 4 and 5 are flow charts illustrating the basic operations performed for the handling of local workarounds by a processor unit with workaround capability such as execution units 214 and 216 (FIG. 4) and by the global workaround controller 218 (FIG. 5). The flow charts for purposes of example show the handling of a singular workaround once configured. As previously noted, an embodiment of the present invention may provide for the handling of multiple workarounds for different units simultaneously by configuring each of a set of forward progress counters (each contained within global workaround controller 218) and triggers both to (“Global Activate signal” from FIG. 3) and from (“Local Workaround Signal” from FIG. 3) each execution unit. Referring first to FIG. 4, at step 402 the triggering logic (310 of FIG. 3) of the execution units 214 and 216 monitor external and internal triggers If, at step 404, a workaround trigger has not been detected, the process proceeds back to step 402 to continue monitoring the triggers. If, however, at step 404, a workaround trigger is detected, and activate signal is sent to the local control logic to initiate workarounds corresponding to the detected trigger. The local control logic (306 from FIG. 3) will then engage any workarounds that are enabled via configuration.

At step 408, a trigger (“Local Workaround Signal” from FIG. 3) is sent to global workaround controller 218 to indicate that the workaround has been activated. At step 410, a “local activate” counter contained within unit triggering logic is reset. The purpose of the local activate counter is to keep track of the duration of the local workaround so that it can be note when it has run for its predetermined number of cycles or other period of time. Thus the counter can be programmed to the predetermined number of cycles it takes for the global workaround controller 218 to “take over” activation of the local workaround by asserting “Global Activate Signal” as in FIG. 3.

At step 412, the triggering logic continues to monitor external and internal triggers just as in step 402. At step 414, if a trigger is detected, the process reverts back to step 408, where a trigger (“Local Workaround Signal” from FIG. 3) is sent to the global workaround controller 218 and the a “local activate” counter is reset. If, however, at step 414, no triggers are detected, the process proceeds to step 416, and the local activate counter is incremented.

By continually monitoring for new triggers while the workaround is engaged, as in steps 412 through 418, workarounds for problem events are not missed inadvertently. For example, if a local trigger is configured to activate when a local workaround must be active for the next three instruction completions, and such a trigger activates when the global workaround controller has already detected forward progress of two instruction completions, then if the re-sending of the trigger in 408 were not performed, the workaround will disengage after the next instruction completion, and will therefore not activate the local workaround as intended.

At step 416, a determination is made as to whether or not the local counter has reached the number of cycles required to guarantee global control is actively setting the local workaround (as previously described in step 410). If the number of cycles has not been reached, the process reverts back to step 412. If the number of cycles has been reached, the process that goes back to step 402 and the monitoring process continues.

FIG. 5 is a flow diagram illustrating the basic steps performed in the global workaround controller 218 when it is handling local workarounds in accordance with the present invention. At step 502, the global workaround controller 218 monitors a set of triggers (“Local Workaround Signals” from FIG. 3) sent by the execution units (214 and 216) that are configured to indicate that a local workaround has been activated. At step 504, if it is determined that no trigger has been detected indicating activation of a workaround, the process proceeds back to step 502 to continue monitoring. If, however, at step 504, a trigger has been detected that indicates the activation of a workaround, at step 506, a trigger (“Global Activate Signal” from FIG. 3) is activated to the execution units keep the initiated workaround active (it will already be active do to unit workaround handling protocol as shown in FIG. 4), and at step 508 a forward progress counter, contained within global workaround controller 218, is initialized by resetting it. At step 510, global workaround controller 218 again monitors a set of triggers (“Local Workaround Signals” from FIG. 3) sent by the execution units (214 and 216) as in step 502. If, at step 512, a workaround trigger is detected, the process proceeds back to step 508 and the forward progress counter is reinitialized by again resetting it, as in step 508. If, however, no such trigger is sensed at step 512, the process proceeds to step 514, where forward progress from completion unit 212 is monitored and the forward progress counter is incremented with each indication of forward progress.

At step 516, a determination is made as to whether or not the predetermined amount of forward progress has been reached. If not, the process reverts back to step 510 to continue monitoring a set of triggers (“Local Workaround Signals” from FIG. 3) sent by the execution units (214 and 216) as in step 502. If the predetermined amount of forward progress has been reached, the process proceeds to step 518 and the trigger (“Global Activate Signal” from FIG. 3) is de-activated to the execution unit causing it to cease operation of the workaround. The process then reverts back to step 502 to continue monitoring the triggers from the execution units.

The present invention therefore provides significant advantages since it can be used to minimize performance loss due to workarounds that must be engaged once the processor has been manufactured. By allowing for the dynamic enablement of workarounds and global control over the disablement of the same, dynamic workarounds may be tailored to engage until a well defined and well suited point in time. As such, this global control makes localized workaround mechanisms usable for a much broader class of problems that may be encountered with complex state-of-the-art processor designs.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage located on the processor of the present invention. In a client/server environment, such software programming code may be stored with storage associated with a server. The software programming code may be embodied on any of a variety of known media for use with a data processing system, such as a diskette, or hard drive, or CD ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, FIGS. 1-5 support combinations of means for performing the specified functions, combinations of steps for performing the specified functions, and program instruction means for performing the specified functions.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. A method of managing the operation of a localized workaround in a processor, comprising:
activating a first localized workaround upon the sensing of a first problematic situation occurring on said processor;
yielding control of deactivation of said first localized workaround to a central controller;
deactivating said first localized workaround based on a deactivation trigger issued by said central controller.

2. The method of claim 1, wherein:
said centralized controller monitors global operations of said processor;
said centralized control issues said deactivation trigger based on results of said monitoring.

3. The method of claim 2, wherein:
said global operations of said processor comprise forward progress of said processor; and
said deactivation trigger is issued when a threshold amount of said forward progress has occurred.

4. The method of claim 3, wherein:
said forward progress is measured using a counter;
upon the sensing of a second problematic situation occurring on said processor, a second localized workaround is activated; and
if said central controller is controlling the deactivation of said first workaround when said second workaround is activated, the counter measuring the forward progress is reset to zero.

5. A processor, comprising:
means for activating a first localized workaround upon the sensing of a first problematic situation occurring on said processor;
a global workaround controller that takes over control of deactivation of said first localized workaround once it becomes active;
means for deactivating said first localized workaround based on a deactivation trigger issued by said global workaround controller.

6. The processor of claim 5, wherein:
said global workaround controller monitors global operations of said processor; and
said global workaround controller issues said deactivation trigger based on results of said monitoring.

7. The processor of claim 6, wherein:
said global operations of said processor comprise forward progress of said processor; and
said deactivation trigger is issued when a threshold amount of said forward progress has occurred.

8. The processor of claim 7, wherein:
said forward progress is measured using a counter;
upon the sensing of a second problematic situation occurring on said processor, a second localized workaround is activated; and
if said global workaround controller is controlling the deactivation of said first workaround when said second workaround is activated, the counter measuring the forward progress is reset to zero.

9. A computer program product for managing the operation of a localized workaround in a processor, the computer program product comprising a computer-readable storage medium having computer-readable program code embodied in the medium, the computer-readable program code comprising:
computer-readable program code that activates a first localized workaround upon the sensing of a first problematic situation occurring on said processor;
computer-readable program code that yields control of deactivation of said first localized workaround to a central controller;
computer-readable program code that deactivates said first localized workaround based on a deactivation trigger issued by said central controller.

10. The computer program product of claim 9, wherein:
said centralized controller monitors global operations of said processor;
said centralized control issues said deactivation trigger based on results of said monitoring.

11. The computer program product of claim 10, Wherein:
said global operations of said processor comprise forward progress of said processor; and
said deactivation trigger is issued when a threshold amount of said forward progress has occurred.

12. The computer program product of claim 11, further comprising:
computer-readable program code that measures said forward progress using a counter;
computer-readable program code that, upon the sensing of a second problematic situation occurring on said processor, activates a second localized workaround; and
if said central controller is controlling the deactivation of said first workaround when said second workaround is activated, the counter measuring the forward progress is reset to zero.
